(19) United States
(12) Patent Application Publication
(10) Pub. No.: US 2014/0376754 A1
(43) Pub. Date: Dec. 25, 2014

(54) METHOD, APPARATUS, AND MANUFACTURE FOR WIRELESS IMMERSIVE AUDIO TRANSMISSION

(71) Applicant: CSR Technology Inc., Sunnyvale, CA (US)

(72) Inventors: Raja Banerjea, San Jose, CA (US); David Trainor, Belfast (IE)

(21) Appl. No.: 13/923,136

(22) Filed: Jun. 20, 2013

(51) Int. Cl. H04R 5/033

(52) U.S. Cl. CPC H04R 5/033
USPC 381/311

(57) ABSTRACT

A method, apparatus, and manufacture for audio transmission is provided. A head-related transfer function (HRTF) profile most accurate for a user is selected from several HRTF profiles. The HFTF is selected by: wirelessly transmitting test signals to binaural headphones, then receiving feedback from the user, and then selecting the HRTF profile based on the feedback. Subsequently, the selected HRTF profile is employed to convert a multi-channel audio signal into a stereo signal such that the stereo signal retains the immersive and spatial audio characteristics of the multi-channel audio signal. Next, the stereo signal is wirelessly transmitted to the binaural headphones.

### TECHNICAL FIELD

The invention is related to signal processing and signal transmission, and in particular, but not exclusively, to a method, apparatus, and manufacture for converting a multi-channel audio signal into a stereo signal and wirelessly transmitting the stereo signal to binaural headphones.

### BACKGROUND

More audio content, in particular cinematic and gaming content, is available in multi-channel audio formats. With the availability of lower-cost home theatre systems, consumers are using multiple speakers and soundbars to render audio in the home.

### BRIEF DESCRIPTION OF THE DRAWINGS

Non-limiting and non-exhaustive embodiments of the present invention are described with reference to the following drawings, in which:

FIG. 1 illustrates a block diagram of an embodiment of a system;

FIG. 2 shows a flowchart of an embodiment of a process that may be employed by an embodiment of the system of FIG. 1;

FIG. 3 illustrates a block diagram of an embodiment of the system of FIG. 1; and

FIG. 4 shows a functional block diagram of an embodiment of the system of FIG. 1, arranged in accordance with aspects of the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. The term “signal” means at least one current, voltage, charge, temperature, data, or other signal.

Briefly stated, the invention is related to a method, apparatus, and manufacture for audio transmission in which a head-related transfer function (HRTF) profile most accurate for a user is selected from several HRTF profiles. The HRTF profile is selected by: wirelessly transmitting test signals to binaural headphones, then receiving feedback from the user, and then selecting the HRTF profile based on the feedback. Subsequently, the selected HRTF profile is employed to convert a multi-channel audio signal into a stereo signal such that the stereo signal retains the immersive and spatial audio characteristics of the multi-channel audio signal. Next, the stereo signal is wirelessly transmitted to the binaural headphones.

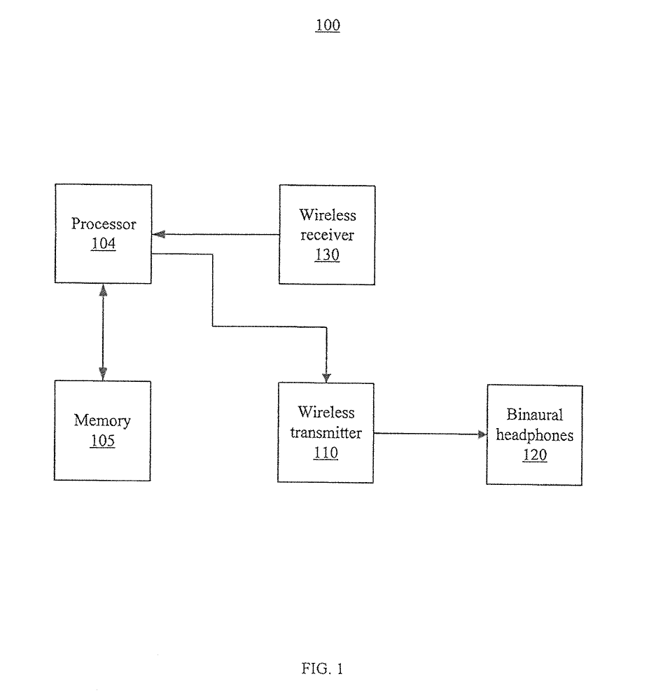

FIG. 1 shows a block diagram of an embodiment of system 100. System 100 includes processor 104, memory 105, wireless transmitter 110, binaural headphones 120, and wireless receiver 130.

During a configuration process, a user may initiate configuration. For example, a configuration request may be received by wireless receiver 130, which provides the configuration request to processor 104. In other embodiments, configuration may be initiated in some other manner; for example, processor 104 may initiate the configuration. Processor 104 may include a CPU or other type of processor, and may include multiple processors in some embodiments. In some embodiments, processor 104 may include a signal processor that is implemented by hardware, software, and/or a combination of hardware and software.

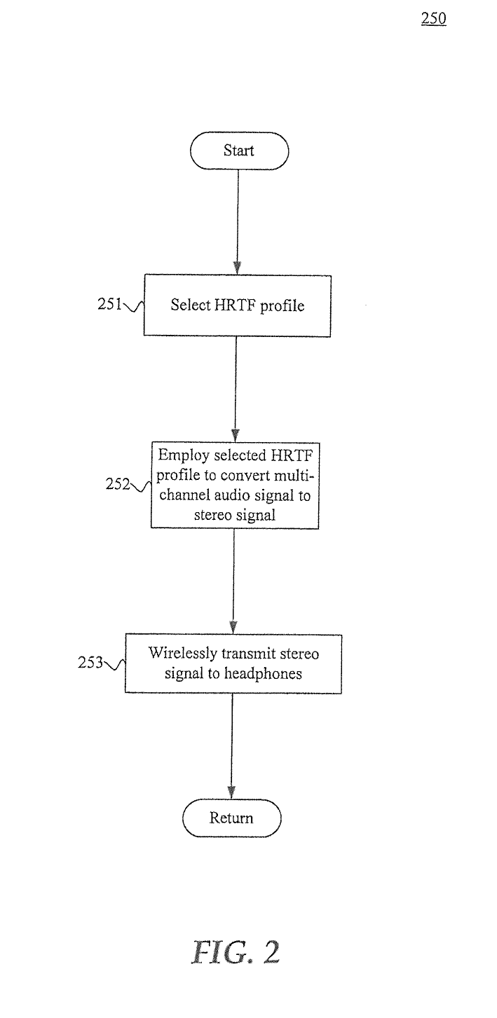

Memory 105 may include a processor-readable medium which stores processor-executable code encoded on the processor-readable medium, where the processor-executable code, when executed by processor 104, enable actions to performed in accordance with the processor-executable code. The processor-executable code may enable actions to perform methods such as those discussed in greater detail below, such as, for example, the process discussed with regard to FIG. 2 below. Memory 105 also stores a collection of head-related transfer functions (HRTFs).

The process of configuration enables processor 104 to select a head-related transfer function (HRTF) profile most accurate for a user from among several HRTF profiles. Each HRTF profile includes one or more HRTFs stored in memory 105. The HRTF profile is selected by: wirelessly transmitting test signals via wireless transmitter 110 to binaural headphones 120 (which may be worn by a user), then receiving feedback from the user (e.g., via wireless receiver 130 or other means), and then selecting the HRTF profile based on the feedback. The selected HRTF profile for the user may be stored in memory 105.

During normal operation, processor 104 employs the selected HRTF profile for the user to convert a multi-channel audio signal into a stereo signal such that the stereo signal retains the immersive and spatial audio characteristics of the multi-channel audio signal. Next, the stereo signal is wirelessly transmitted to binaural headphones 120 via wireless transmitter 110. In some embodiments, binaural headphones 120 may be part of a headset. In other embodiments, binaural headphones 120 are not part of a headset.

Wireless transmitter 110 is a device capable of wirelessly transmitting an audio signal. In some embodiments, the transmission is accomplished via Bluetooth connectivity and the A2DP Bluetooth profiles. In other embodiments, other forms of wireless transmission may be employed by wireless transmitter 110. Wireless receiver 130 is a device capable of wirelessly receiving commands from a user. In some embodiments, the reception is accomplished via Bluetooth connectivity and the AVRCP Bluetooth profiles. In other embodiments, other forms of wireless reception may be employed by wireless receiver 130.

Although a particular diagram of system 100 showing one particular embodiment of system 100 is illustrated in FIG. 1, many additional components, not shown in FIG. 1, may also be present in system 100. Also, although FIG. 1 illustrates and discusses wireless receiver 130, wireless receiver 130 is an optional component that is not included in all embodiments of FIG. 1. For example, in some embodiments, the user may provide feedback based on the test signals through some means of input other than wireless transmission. These embodiments and others are within the scope and spirit of the invention.

FIG. 2 shows a flowchart of an embodiment of process 250, which may be employed by an embodiment of processor 104 of FIG. 1.

After a start block, the process proceeds to block 251, where a head-related transfer function (HRTF) profile most accurate for a user is selected from several HRTF profiles. Subsequently, the process moves to block 252, where the selected HRTF profile is employed to convert a multi-channel audio signal into a stereo signal such that the stereo signal retains the immersive and spatial audio characteristics of the multi-channel audio signal. The process then advances to block 253, where the wireless transmission of the stereo signal to the binaural headphones is enabled. The process then proceeds to a return block, where other processing is resumed.

In some embodiments, the act at block 251 may be accomplished by wirelessly transmitting test signals to binaural headphones, then receiving feedback from the user, and then selecting the HRTF profile based on the feedback.

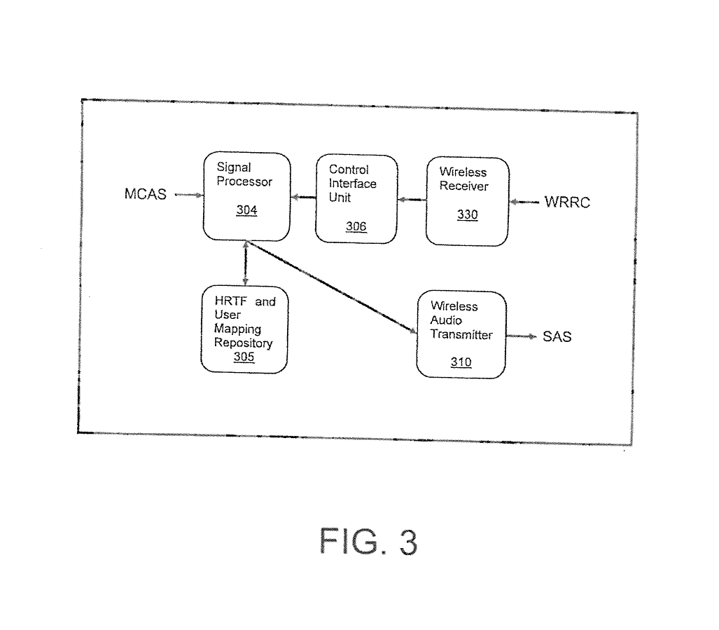

FIG. 3 illustrates a block diagram of an embodiment of system 300, which may be employed as an embodiment of system 100 of FIG. 1. System 300 includes signal processor 304, HRTF and user mapping repository 305, control interface unit 306, wireless receiver 330, and wireless audio transmitter 310. Signal processor 304 may be employed as an embodiment of processor 104 of FIG. 1. HRTF and user mapping repository 305 may be employed as an embodiment of memory 105 of FIG. 1. Wireless receiver 330 may be employed as an embodiment of wireless receiver 130 of FIG. 1. Wireless audio transmitter 310 may be employed as an embodiment of wireless transmitter 110 of FIG. 1.

In some embodiments, system 300 may operate in a similar manner as discussed above for system 100 of FIG. 1. Control interface unit 306 may be configured to interpret received control commands and configure adjustable parameters of the operation of signal processor 304 via a suitable interface with signal processor 304.

In some embodiments, system 300 may be employed to allow a convincing immersive audio effect to be achieved employing conventional stereo wireless headphones and stereo wireless audio connectivity. Audio content is increasingly available in multi-channel audio formats, and consumers are using multiple speakers and soundbars to render audio in the home. Multi-speaker audio systems are also increasing in sophistication in automotive markets. In order to achieve privacy or sound isolation, consumers may wish to wear headphones and listen to the multi-channel audio while watching the video on a display. And with 3D video increasing in popularity, users wear 3D video glasses to watch content on 3D televisions and displays.

System 300 may be employed to generate the immersive audio effect in the TV, Blu-Ray player, A/V receiver, laptop, mobile device, computer, set-top device, and/or the like, and wirelessly transmit the immersive audio effect to the headphones. By using system 300, the wireless link to the headphones and the headphone processing need only operate on conventional stereo audio streams, but the consumer wearing the headphones still perceives the immersive audio effect. So the wireless headphones may accordingly be designed for efficient stereo operation, prolonging battery life, and minimizing wireless network bandwidth. System 300 operates as a wireless immersive audio transmission system that applies and configures processing to create a high-quality immersive audio effect from a stereo audio stream.

Signal processor 304 receives multi-channel immersive audio signal MCAS and down-mixes signal MCAS into a stereo (2-channel) audio signal while preserving the immersive and spatial audio characteristics of the audio signal. In various embodiments, signal processor 304 may be implemented as hardware, software, and/or any appropriate combination of hardware and software.

HRTF and user mapping repository 305 includes multiple data records, accessible by signal processor 304, in which each record contains multiple data values representing a different Head-Related Transfer Function (HRTF). HRTF and user mapping repository 305 also includes multiple data records in which each record contains a mapping between an authorized user of the system and a subset of the stored HRTFs that give the most accurate immersive effects for that user.

Wireless audio transmitter 310 is capable of reliable transmission of high-quality stereo audio signal SAS. In some embodiments, this transmission is achieved using Bluetooth connectivity and the A2DP Bluetooth profile.

Wireless receiver 330 is capable of reliable reception of remote control commands WRRC from the consumer for the purposes of configuring and adjusting the immersive audio transmission. In some embodiments, this reception is achieved using Bluetooth connectivity and the AVRCP Bluetooth profile.

Control interface unit 306 is configured to interpret the wireless received remote control commands WRRC and to adjust parameters of the operation of signal processor 304 via a suitable interface with signal processor 304.

A head-related transfer function (HRTF) describes the filtering characteristics applied to an input audio signal by the physiology of the ear (pinna shape, ear canal shape) and the head shape of a given listener, all of which alters the frequency and phase response of the input signal. Due to the spatial separation of the ears, occlusion by the head, and the acoustic environment (e.g. reflections) inter-aural time, level and intensity differences are introduced. Essentially, an HRTF can be considered as a filter and different HRTFs, and hence different spatial effects, can be represented by different sets of filter coefficients.

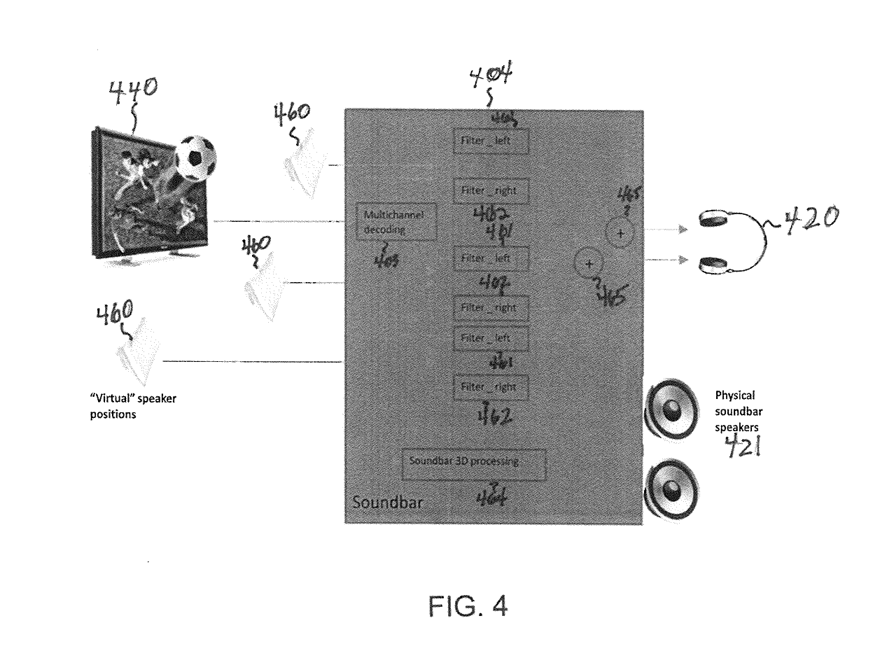

FIG. 4 shows a functional block diagram of an embodiment of system 400, which may be employed as an embodiment of system 100 of FIG. 1. System 400 includes audio source 440, soundbar 404, virtual speaker positions 460, binaural headphones 420, and physical soundbar speakers 421. Soundbar 404 includes multichannel decoding block 463, left filters 461, right filters 462, soundbar 3D processing block 464, and summers 465.

System 400 is arranged to provide surround/3D/immersive audio. A traditional home theatre topology may employ, for example, 5.1 or 7.1 speaker layouts. By applying the correct HRTFs for the left and right ear across to each audio channel, it is possible to recreate the multi-speaker sound field (of a traditional home theatre topology) via the stereo signal delivered by headphones 420. Signal processing in TV soundbar 404 may be employed to deliver surround/3D/immersive audio from a multi-channel audio input using signal processing and multiple speaker drivers to create the effect of many “virtual” speakers at “virtual” speaker positions 460. Again, by applying the appropriate HRTFs for the left and right ear across each audio channel, it is possible to recreate the “virtual” multi-speaker sound field via the stereo signal delivered by headphones 420 as shown in FIG. 4.

Audio source 440 provides a multi-channel audio signal to soundbar 404. In various embodiments, audio source 440 may include a TV, Blu-ray player, A/V receiver, laptop, mobile device, computer, set-top device, and/or the like. Multichannel decoding block 463, left filters 461, right filters 462, and summers 465 operate together to convert the multi-channel audio signal into a stereo signal such that the stereo signal retains the immersive and spatial audio characteristics of the multi-channel audio signal, and the stereo signal is then wirelessly transmitted to headphones 420.

During this processing, each channel of the multi-channel audio signal, such as each of the five channels of a 5.1 multi-channel audio signal, is filtered by left and right digital filters based on the coefficients provided from the loaded HRTF, and the filtered channels are combined to provide the stereo signal. A user listening to the headphones will hear sound such that the sound seems to come from “virtual” speaker positions 460. Soundbar 3D processing 464 converts the multi-channel audio signal into a stereo signal such that the stereo signal retains the immersive and spatial audio characteristics of the multi-channel audio signal when output from physical soundbar speakers 421, and then provides the signal to physical soundbar speakers 421 to output audio such that the audio seems to come from “virtual” speaker positions 460.

Returning now to FIG. 3, at the point of device manufacture, a small database of different HRTFs is loaded into the persistent storage of the HRTF and User Mapping Repository 305. In some embodiments, this set of HRTFs is derived using clustering techniques such as those described in the report “Improved Localisation and Externalisation of Non-individualised HRTFs by Cluster Analysis” by Robert Tame, hereby incorporated by reference, so that the HRTF database may maximize the applicability and performance levels achievable from a configured HRTF database of given size.

In some embodiments, when a consumer first uses system 300, the consumer participates in a short initial configuration exercise. Also, in some embodiments, during this initial configuration exercise, a predefined sequence of test signals, processed with each of the stored HRTFs by signal processor 304, is presented to the consumer over the connected wireless headphones 320, using wireless audio transmitter of 310. In these embodiments, using the product remote control to indicate perceived spatial position on a graphic on the product display, the consumer indicates the perceived direction and externalization of each test signal.

These indications from the consumer are sent to wireless receiver 330, and from wireless receiver 330 to control interface unit 306 and from control interface unit 306 to signal processor 304 of FIG. 3. Signal processor 304 calculates the subset of HRTFs in the database that give the most accurate levels of direction and externalization for this particular consumer by comparing the true direction and externalization of each test signal with the perceived values indicated by the consumer. The best subset of HRTFs in HRTF and User Mapping Repository 305 for this particular consumer is the “HRFT profile” for the consumer, and is stored in the repository 305 for future recall, to avoid repetition of the configuration exercise for this consumer.

In some embodiments, HRTF and user mapping repository 305 stores a relatively small collection of carefully chosen profiles or settings that HRTF and user mapping repository 305 can deploy in different ways in order to provide effective experience for different individuals. The collection of profiles stored is carefully chosen to maximize the probability that at least one of them will get a good experience for as many users as possible. In some embodiments, different classes of users are clustered under each HRTF data block, and the collection of HRFT data blocks are selected to get as complete coverage for the entire user base as possible, while having minimum overlap and redundancy between any two HRTF profiles. Each HRTF is basically a set of numeric parameters to be provided to digital filters when converting the multi-channel audio signal into the stereo signal.

As discussed above, in some embodiments, the set of HRTFs may be derived using clustering techniques such as those described in the report “Improved Localisation and Externalisation of Non-individualised HRTFs by Cluster Analysis” by Robert Tame. However, a variety of different techniques for generating the set of HRTFs may be employed in various embodiments, including, for example, K-means clustering, Linde-Buzo-Gray (LBG) clustering, frequency scaling of a base HRTF, composition of HRTFs from responses of structural components, and/or Multiple Regression Analysis. These embodiments and others are within the scope and spirit of the invention.

The collection of profiles to be stored in HRTF and user mapping repository 305 is chosen and stored during the design of HRTF and user mapping depository 305. Then, during the initial configuration for the consumer, one of these HRTF profiles is selected for the consumer. Each user may go through a separate initial configuration process, where a separate selection of one of the HRTF profiles is made for each user.

When a consumer wishes to listen to immersive audio on their wireless headphones, they can connect the headphones and, if it is not already loaded, load the consumer's HRTF profile via commands from the product remote control. The multi-channel audio is then decoded (if necessary) into discrete uncoded audio channels. In some embodiments, the appropriate HRTFs are applied based on the particular consumer using the product and the desired multi-speaker topology (whether physical or “virtual” speakers) and the left and right channels from each HRTF filter are combined as illustrated in FIG. 4. This processing is conducted by signal processor 304. The resulting stereo audio stream is sent to wireless audio transmitter 310, and from wireless audio transmitter 310 to the wireless headphones where the resulting stereo audio stream is rendered for the consumer.

In some embodiments, a consumer listening to audio on the headphones may apply an additional immersive audio effect, for example increasing externalization or the perception of “width” or “height”. Via suitable commands from the product remote control, which are received and processed by wireless receiver 330, control interface unit 306, and signal processor 304, revised or modified HRTFs are selected from HRTF and User Mapping Repository 305 to create the modified immersive effect.

System 300 provides multi-channel spatial audio processing on the transmission side of the wireless audio connection, which may enable optimization of the performance of the wireless communications network and the battery-powered audio receiving device, while retaining the ability of the end user to personalize and control the system from the audio receiving device. System 300 allows a convincing immersive audio effect to be achieved using conventional stereo wireless headphones and stereo wireless audio connectivity.

Accordingly, consumers may experience immersive audio using cost-effective peripheral equipment. The complex spatial audio processing occurs in mains-powered consumer electronics devices that already represent a much higher investment than headphones and therefore can more easily absorb the relatively small incremental cost and processing overhead. System 300 also allows the consumer a significant degree of optimization and control over the immersive effect without requiring a complex and lengthy configuration process.

The above specification, examples and data provide a description of the manufacture and use of the composition of the invention. Since many embodiments of the invention can be made without departing from the spirit and scope of the invention, the invention also resides in the claims hereinafter appended.

What is claimed is:

1. A method, comprising:
selecting, from a plurality of head-related transfer function profiles, a head-related transfer function profile accurate for a user by: employing a wireless transmitter to wirelessly transmit test signals to binaural headphones; after employing the wireless transmitter to wirelessly transmit the test signals to the binaural headphones, receiving feedback from the user; and selecting the head-related transfer function profile from the plurality of head-related transfer function profiles based on the feedback, wherein each head-related transfer function profile includes at least one head-related transfer function;
employing the selected head-related transfer function profile to convert a multi-channel audio signal having immersive and spatial audio characteristics into a stereo signal such that the stereo signal retains the immersive and spatial audio characteristics of the multi-channel audio signal; and
after converting the multi-channel audio signal into the stereo signal such that the stereo signal retains the immersive and spatial audio characteristics of the multi-channel audio signal, employing the wireless transmitter to wirelessly transmit the stereo signal to the binaural headphones.

2. The method of claim 1, wherein employing the wireless transmitter to wirelessly transmit the stereo signal to the binaural headphones is accomplished by Bluetooth connectivity.

3. The method of claim 1, further comprising altering at least one of the head-related transfer functions in the selected head-related transfer function profile based on a received command from the user.

4. The method of claim 1, further comprising:
storing a plurality of pre-determined head-related transfer functions including the at least one head-related transfer function, wherein each head-related transfer function profile of the plurality of head-related transfer function profiles includes a subset of the plurality of pre-determined head-related transfer functions; and
processing a plurality of pre-defined unprocessed test signals with each of the plurality of pre-determined head-related transfer functions to generate the test signals to be wirelessly transmitted to the binaural headphones.

5. The method of claim 4, wherein each pre-determined head-related transfer function of the plurality of pre-determined head-related transfer function includes a plurality of numeric parameters for audio filtering, and wherein converting the multi-channel audio signal into the stereo signal such that the stereo signal retains the immersive and spatial audio characteristics of the multi-channel audio signal includes filtering the multi-channel audio signal using each of the plurality of numeric parameters for audio filtering of each head-related transfer function in the selected head-related transfer function profile.

6. The method of claim 4, wherein the plurality of pre-determined head-related transfer functions are pre-determined based on at least one of K-means clustering, Linde-Buzo-Gray clustering, frequency scaling of a base head-related transfer functions, composition of head-related transfer functions from responses of structural components, or Multiple Regression Analysis.

7. The method of claim 4, wherein the feedback from the user includes an indication by the user of a perceived direction and externalization of each of the test signals, and wherein selecting the head-related transfer function profile from the plurality of head-related transfer function profiles based on the feedback is accomplished by selecting the head-related transfer function profile for which the perceived direction and externalization for each of the test signals matches most closely to the actual direction and externalization of the test signals.

8. An apparatus, comprising:
a memory that is configured to store a plurality of head-related transfer function profiles, wherein each head-related transfer function profile includes at least one head-related transfer function; and
a processor that is configured to execute code that enables actions, including:
selecting, from the plurality of head-related transfer function profiles, a head-related transfer function profile accurate for a user by: controlling a wireless transmitter to wirelessly transmit test signals to binaural headphones; after controlling the wireless transmitter to wirelessly transmit the test signals to the binaural headphones, receiving feedback from the user; and selecting the head-related transfer function profile from the plurality of head-related transfer function profiles based on the feedback;
employing the selected head-related transfer function profile to convert a multi-channel audio signal having immersive and spatial audio characteristics into a stereo signal such that the stereo signal retains the immersive and spatial audio characteristics of the multi-channel audio signal; and
after converting the multi-channel audio signal into the stereo signal such that the stereo signal retains the immersive and spatial audio characteristics of the multi-channel audio signal, controlling the wireless transmitter to wirelessly transmit the stereo signal to the binaural headphones.

9. The apparatus of claim 8, wherein the processor includes a signal processor.

10. The apparatus of claim 8, further comprising a wireless receiver that is arranged to wirelessly receive the feedback from the user, and to provide the feedback to the processor.

11. The apparatus of claim 8, further comprising the wireless transmitter.

12. The apparatus of claim 11, wherein the wireless transmitter is configured to wirelessly transmit the stereo signal to the binaural headphones via Bluetooth connectivity.

13. The apparatus of claim 8, wherein the memory is further configured to store a plurality of pre-determined head-related transfer functions including the at least one head-related transfer function, and wherein the memory is further configured such that each head-related transfer function profile of the plurality of head-related transfer function profiles includes a subset of the plurality of pre-determined head-related transfer functions.

14. The apparatus of claim 13, wherein the processor is further configured to process a plurality of pre-defined unprocessed test signals with each of the plurality of pre-determined head-related transfer functions to generate the test signals to be wirelessly transmitted to the binaural headphones.

15. The apparatus of claim 14, wherein the memory is further configured such that each pre-determined head-related transfer function of the plurality of pre-determined head-related transfer function includes a plurality of numeric parameters for audio filtering, and wherein the processor is further configured to convert the multi-channel audio signal into the stereo signal such that the stereo signal retains the immersive and spatial audio characteristics of the multi-channel audio signal by filtering the multi-channel audio signal using each of the plurality of numeric parameters for audio filtering of each head-related transfer function in the selected head-related transfer function profile.

16. The apparatus of claim 14, wherein the feedback from the user includes an indication by the user of a perceived direction and externalization of each of the test signals, and wherein the processor is further configured to select the head-related transfer function profile from the plurality of head-related transfer function profiles based on the feedback is by selecting the head-related transfer function profile for which the perceived direction and externalization for each of the test signals matches most closely to the actual direction and externalization of the test signals.

17. A tangible processor-readable storage medium that arranged to encode processor-readable code, which, when executed by one or more processors, enables actions, comprising:
selecting, from a plurality of head-related transfer function profiles, a head-related transfer function profile accurate for a user by: controlling a wireless transmitter to wirelessly transmit test signals to binaural headphones; after controlling the wireless transmitter to wirelessly transmit the test signals to the binaural headphones, receiving feedback from the user; and selecting the head-related transfer function profile from the plurality of head-related transfer function profiles based on the feedback, wherein each head-related transfer function profile includes at least one head-related transfer function;
employing the selected head-related transfer function profile to convert a multi-channel audio signal having immersive and spatial audio characteristics into a stereo signal such that the stereo signal retains the immersive and spatial audio characteristics of the multi-channel audio signal; and
after converting the multi-channel audio signal into the stereo signal such that the stereo signal retains the immersive and spatial audio characteristics of the multi-channel audio signal, controlling the wireless transmitter to wirelessly transmit the stereo signal to the binaural headphones.

18. The tangible processor-readable storage medium of claim 17, the actions further comprising:
storing a plurality of pre-determined head-related transfer functions including the at least one head-related transfer function, wherein each head-related transfer function profile of the plurality of head-related transfer function profiles includes a subset of the plurality of pre-determined head-related transfer functions; and
processing a plurality of pre-defined unprocessed test signals with each of the plurality of pre-determined head-related transfer functions to generate the test signals to be wirelessly transmitted to the binaural headphones.

19. A system, comprising:
a wireless transmitter;
binaural headphones;
a user device that is configured to provide control commands; and
a device that is configured to perform actions, including:
selecting, from a plurality of head-related transfer function profiles, a head-related transfer function profile accurate for a user by: controlling the wireless transmitter to wirelessly transmit test signals to the binaural headphones; after controlling the wireless transmitter to wirelessly transmit the test signals to the binaural headphones, receiving the control commands including feedback from the user device; and selecting the head-related transfer function profile from the plurality of head-related transfer function profiles based on the feedback, wherein each head-related transfer function profile includes at least one head-related transfer function;
employing the selected head-related transfer function profile to convert a multi-channel audio signal having immersive and spatial audio characteristics into a stereo signal such that the stereo signal retains the immersive and spatial audio characteristics of the multi-channel audio signal; and
after converting the multi-channel audio signal into the stereo signal such that the stereo signal retains the immersive and spatial audio characteristics of the multi-channel audio signal, controlling the wireless transmitter to wirelessly transmit the stereo signal to the binaural headphones.

20. The system of claim 19, wherein the device is configured to perform further actions, comprising:
storing a plurality of pre-determined head-related transfer functions including the at least one head-related transfer function, wherein each head-related transfer function profile of the plurality of head-related transfer function profiles includes a subset of the plurality of pre-determined head-related transfer functions; and
processing a plurality of pre-defined unprocessed test signals with each of the plurality of pre-determined head-related transfer functions to generate the test signals to be wirelessly transmitted to the binaural headphones.
